(19) United States
(12) Patent Application Publication
(10) Pub. No.: US 2023/0228669 A1
(43) Pub. Date: Jul. 20, 2023

(54) SURFACE CORROSION MONITORING SYSTEM

(71) Applicant: WISEGROW INVESTMENTS PTY LTD, Kensington (AU)

(72) Inventor: Giles HARRISON, Kensington (AU)

(21) Appl. No.: 17/999,766

(22) PCT Filed: May 25, 2021
(86) PCT No.: PCT/AU2021/050489

§ 371 Date: Nov. 23, 2022

(30) Foreign Application Priority Data
May 29, 2020 (AU) 2020901766

(51) Int. Cl. G01N 17/02

(52) U.S. Cl. CPC G01N 17/02

(57) ABSTRACT

A surface corrosion monitoring system for a containment structure is disclosed. The surface corrosion monitoring system includes an electrode arrangement comprising an electrode electrically coupled with said structure, and a DC power supply arranged, in use, to deliver a predetermined voltage to the electrode which is sufficient to passivate and/or polarise or immunise an interior surface of said structure. The system also includes an electrode array comprising a plurality of spaced reference electrodes mounted on a framework, wherein each reference electrode is proximal to a localised interior surface of said structure and is arranged to measure a local potential indicative of current demand of the localised interior surface of the containment structure. A monitoring unit is also provided to monitor the local potentials measured by respective reference electrodes.

### TECHNICAL FIELD

The disclosure relates to surface corrosion monitoring system and a method of identifying and quantifying localised corrosion on a structure surface. Advantageously, said system and method also acts to reduce or cease corrosion to the structure surface.

### BACKGROUND

The discussion of the background to the disclosure is intended to facilitate an understanding of the disclosure. However, it should be appreciated that the discussion is not an acknowledgement or admission that any of the material referred to was published, known or part of the common general knowledge as at the priority date of the application.

Many extractive mineral processes, such as leaching and adsorption, are performed in large volume steel tanks. The internal surfaces of the tanks are subject to a number of corrosion mechanisms resulting from chemical, mechanical, erosion, abrasion, biological and galvanic processes. Corrosion rates of up to 12 mm per year have been observed, leading to tank perforation and, in the extreme cases, catastrophic failure.

Although corrosion is not favoured under high alkalinity conditions (pH ≥ 9), it is nonetheless industry best practice to apply a protective coating to internal surfaces of the tank, including associated internal structures such as baffles, downcomers, launders, agitators and sparges. Other structures within the tanks, such as screens, where it is not feasible to have a protective coating applied thereon are made from corrosion resistant materials such as stainless steels, although these can also be subject to corrosion and abrasion over time. Poor coating application, mechanical damage and corrosion to the coated surface may be a result of defects in and/or damage to the protective coating in a highly conductive and aggressive environment. Due to the abrasive nature of the slurry, rapid coating deterioration, corrosion and tank perforation will result wherever coating defects, damage and/or degradation results in a failure of the coating barrier.

Inspection generally involves identification of coating and steel defects (i.e. mechanical damage, blisters, cracks, localised metal loss, etc) via visual means, sampling and data collection, destructive and non-destructive testing, followed by analytical testing as necessary. Typically, the current maintenance procedure is to empty each tank every two to three years for up to two months to carry out maintenance inspections and coating repairs to ensure ongoing reliability of the steel tank.

It would be advantageous to have a monitoring system associated with such tanks to identify instances of corrosion during operation and to monitor the extent of corrosion progress over time. Additionally, it would be advantageous to have a conditioning system associated with such tanks, as well as other structures or components associated therewith that are also vulnerable to corrosion, to continually electrochemically affect or condition internal surfaces thereof, even when a corrosion event occurs, thereby mitigating corrosion damage.

The present disclosure seeks to overcome at least some of the aforementioned disadvantages.

### SUMMARY

The disclosure provides a surface corrosion monitoring system and a method of identifying and quantifying localised corrosion on a structure surface.

One aspect of the disclosure provides a surface corrosion monitoring system comprising:
an electrode arrangement for electrolytic protection of a containment structure or component associated therewith, the electrode arrangement comprising an electrode electrically coupled with said structure or component, and a DC power supply arranged, in use, to deliver a predetermined voltage to the electrode, thereby causing the electrode to behave as an anode or a cathode and said structure to behave as the other cathode or anode, respectively, the predetermined voltage being sufficient to passivate and/or polarise or immunise an interior surface of said structure or component;
an electrode array comprising a plurality of spaced reference electrodes mounted on a framework, wherein the framework is configured to dispose each reference electrode proximal to a localised interior surface of said structure or component and each reference electrode in said array is arranged to measure a local potential indicative of current demand to maintain passivation and/or polarisation or immunity of the localised interior surface of the containment structure or the component; and,
a monitoring unit operative to monitor the local potentials measured by respective reference electrodes.

In one embodiment, the containment structure may be a tank, in particular a tank for containing process liquors. Generally, the process liquors have a high total dissolved solids content (TDS) and consequently they behave as electrolytes and conduct an electric current.

In an alternative embodiment, the containment structure may be one or more pipes in fluid communication with one another, in particular one or more pipes for conveying process liquors.

In an alternative embodiment, the containment structure may be a launder.

In one embodiment, the component may be one or more of a screen, baffle, baffle support, agitator and so forth.

In one embodiment, the framework is suspended in the containment structure from an overhead structure capable of supporting said framework and reference electrodes mounted thereon. Alternatively, the framework may be suspended in the containment structure from one or more fixing points capable of supporting said framework and reference electrodes mounted thereon. In one embodiment, the plurality of reference electrodes may be regularly spaced from one another.

In one embodiment, the framework comprises a cylindrical lattice. The framework may be disposed proximal to the interior surface of the containment structure. In some embodiments, the framework may be disposed at a distance of about 50 cm to about 200 cm from the interior surface of the containment structure.

In some embodiments, the plurality of reference electrodes may be arranged on the cylindrical framework in a radial pattern within a lateral plane and at regular intervals within a longitudinal plane.

In one embodiment, the reference electrode comprises a Ag/AgCI electrode. The reference electrode may be provided with a protective shroud.

In one embodiment, the monitoring unit is in operative communication with a graphic user interface, optionally via online data storage, to provide a graphical representation of the respective measured local potentials of the interior surface of the containment structure. The graphical representation may illustrate a variation of the respective measured local potential from the predetermined voltage applied and the current applied to the containment structure or component and thereby identify where corrosion may be present or occurring at a localised interior surface of the containment structure or component.

Another aspect of the disclosure provides a method of identifying and quantifying localised corrosion in a containment structure or component associated therewith, the method comprising:
providing an electrode arrangement for electrolytic protection of the containment structure, the electrode arrangement comprising an electrode electrically coupled with said structure or component, and a DC power supply arranged, in use, to deliver a predetermined voltage to the electrode, thereby causing the electrode to behave as an anode or a cathode and said structure to behave as the other cathode or anode, respectively;
delivering a predetermined voltage to the electrode sufficient to passivate and/or polarise or immunise a surface of said structure or component;
disposing an electrode array in an interior space defined by said structure, wherein the electrode array comprises a plurality of spaced reference electrodes mounted on a framework, wherein the framework is configured to dispose each reference electrode proximal to a localised interior surface of said structure;
measuring a local potential at the localised surface of the containment structure or component with the respective reference electrode, wherein the local potential is indicative of current demand to maintain the passivated and/or polarised surface; and
monitoring the local potentials measured at respective localised surfaces of the containment structure or component to identify a variation of the local potential from the predetermined voltage.

In one embodiment, the predetermined voltage to passivate or immunise the surface of said structure may be in a range from (-)800 mV to (-)1000 mV, in particular from (-)850 mV to (-)950 mV v Ag/AgCI reference electrode. It will be appreciated that a reference to (-) with respect to a potential (mV) refers to the fact that the potential may be positive or negative, depending on whether the electrode is behaving as a cathode or an anode, respectively. The predetermined voltages defined above may be particularly relevant to a gold cyanidation process as described herein. It will be appreciated that the predetermined voltage range may vary according to the specific process conditions in the containment structure (e.g. pH, metal ions in solution, and so forth).

In one embodiment, the variation of the local potential from the predetermined voltage may be indicative of corrosion in the vicinity of the localised internal surface of the tank or on the component.

In one embodiment, the step of measuring the local potential is performed continuously or intermittently over a period of time. For example, the measuring step may be performed intermittently at regular intervals of 5 min, 30 min, 1 h, 24 h or even 48 h.

Another aspect of the disclosure provides a containment structure comprising a surface corrosion monitoring system as defined above.

### BRIEF DESCRIPTION OF DRAWINGS

Notwithstanding any other forms which may fall within the scope of the process as set forth in the Summary, specific embodiments will now be described with reference to the accompanying figures below:

FIG. 1 is a schematic representation of one embodiment of a surface corrosion monitoring system deployed in a process tank;

FIG. 2 is a schematic representation of surface corrosion monitoring system shown in FIG. 1; and

FIG. 3 is an example of a graphical depiction of localised corrosion occurring on an interior surface of a process tank in accordance with one embodiment of the method as disclosed herein.

### DESCRIPTION OF EMBODIMENTS

The disclosure relates to surface corrosion monitoring system and a method of identifying and quantifying localised corrosion on a structure surface.

### General Terms

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.).

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Reference to positional descriptions, such as lower and upper, are to be taken in context of the embodiments depicted in the figures, and are not to be taken as limiting the invention to the literal interpretation of the term but rather as would be understood by the skilled addressee.

Spatially relative terms, such as “inner,” “outer,” “beneath”, “below”, “lower”, “above”, “upper” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

The term “about” as used herein means within 5%, and more preferably within 1%, of a given value or range. For example, “about 3.7%” means from 3.5 to 3.9%, preferably from 3.66 to 3.74%. When the term “about” is associated with a range of values, e.g., “about X% to Y%”, the term “about” is intended to modify both the lower (X) and upper (Y) values of the recited range. For example, “about 20% to 40%” is equivalent to “about 20% to about 40%”.

### Specific Terms

The term “corrosion” refers to a degradative process in which a metal or an alloy is converted by a chemical and/or electrochemical reaction to a chemically more stable oxide, hydroxide or sulphide compound. Examples of corrosion to a metal surface include, but are not limited to, rusting, metal dissolution or erosion, pitting, peeling, blistering, patina formation, cracking, embrittlement, and any combination thereof.

The term ‘electrolytic protection’ may refer to cathodic protection or anodic protection. Cathodic protection refers to an arrangement whereby corrosion of a metal structure is controlled by connecting the metal structure to an anode and a direct current (DC) electrical power source thereby making the metal structure the cathode of an electrochemical cell. To effect cathodic protection, the DC electrical power source supplies a current at predetermined negative potential to the metal structure sufficient to prevent corrosion. Anodic protection refers to an arrangement whereby corrosion of a metal structure is controlled by connecting the metal structure to a cathode and a DC electrical power source, thereby making the metal structure the anode of the electrochemical cell and controlling the electrode potential in a zone where the metal structure is passive.

The term ‘passivation’ as used herein refers to the formation of a film of corrosion products, known as a passive film, on the metal’s surface that acts as a barrier to further oxidation. The term ‘passivate’ as used herein refers to the process of forming the film of corrosion products on the metal’s surface. Generally, the corrosion products are one or more metal oxides which are inert to further oxidation.

The term ‘polarisation’ as used herein refers to the change in potential of a structure being protected from a stable state (open circuit potential or free corroding potential) to a potential that is more or less than the steady state as the result of a passage of current. Several effects may arise at an interface between an electrolyte and an electrode arising from an electrochemical process, leading to a negative shift in reduction potential of the electrode relative to a reference electrode. Examples of such effects include, but are not limited to accumulation of gasses at the interface between the electrode and electrolyte and uneven depletion of reagents in the electrolyte causing concentration gradients in the boundary layers of the interface. Collectively, the result of such polarisation effects is to isolate the electrode from the electrolyte, thereby impeding reaction and charge transfer between them. The term ‘polarise’ as used herein refers to the electrochemical process that causes such effects to occur.

The term ‘immunity’, ‘immunise’ or variants thereof as used herein refers to supplying a current at a predetermined voltage to achieve a cathodic potential shift to the metal structure such that it remains thermodynamically stable in its environment.

### Surface Corrosion Monitoring System

Embodiments described herein generally relate to a surface corrosion monitoring system. While the disclosure is made in the context of monitoring surface corrosion of leach tanks used in gold cyanidation, it will be appreciated that the disclosure has general application in monitoring and reducing the effect of corrosion of leach tanks, adsorption tanks and process tanks where it is undesirable for corrosion to occur. Other examples where the system as described herein may have a general principle of application include, but are not limited to, one or more pipes in fluid communication with one another for conveying process liquors, launders, screens, reactors, columns, cells, leaching circuits, adsorption circuits, carbon in pulp and so forth.

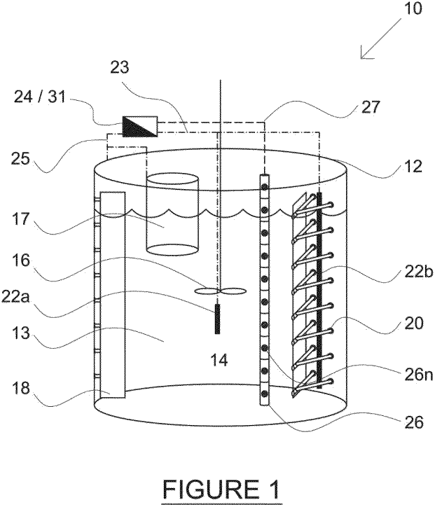

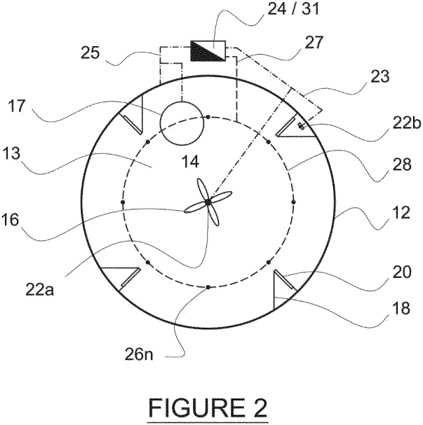

Referring to FIGS. 1 and 2, there is shown a surface corrosion monitoring system 10 in association with a process tank 12 used in gold cyanidation. The process tank 12 may vary in height and capacity, and is typically between 5 m to 14 m in height with a capacity of 100 m³ to 2000 m³. The process tank 12 may be fabricated from a variety of materials including, but not limited to, galvanised steel, stainless steel, carbon steel, mild steel, fibreglass, fibre reinforced plastic, concrete and so forth.

The process tank 12, in particular an interior surface 14 thereof, may be subject to an abrasive and corrosive environment. In gold cyanidation, for example, the dissolution of gold in aqueous solution involves oxidation of gold into ionic species coupled with a complexation process with cyanide to stabilize the gold ion in solution as per equation (1):

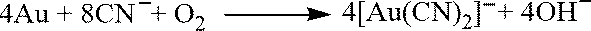

Contents 13 of the process tank 12 contains a mixture of a gold ore slurry, sodium cyanide, as well as buffers to maintain alkaline conditions (pH > 9) and, optionally, dissolution accelerants, such as lead nitrate. The mixture is aerated by sparging with oxygen or air and mixed with an agitator 16, such as an impeller. Activated carbon may be added to the process tank 12 and pumped counter current to the slurry through a process circuit or train of process tanks. The cyanide gold complex is adsorbed onto the activated carbon’s large surface area and the “loaded carbon” is collected in a screen 17 and removed for further processing to extract the gold. It will be appreciated that gold cyanidation plants may adopt different plant configurations that either treat the leaching and adsorption process in one series of process tanks or in separate banks of process tanks.

It will be appreciated that the interior surface 14 of the process tank 12 is subject to abrasion by the flow of fines in the slurry, with areas of increased turbulent flow normally associated with baffles 18 and the baffle supports 20. Additionally, process water may have a high TDS content of 20,000 to 300,000 ppm.

The interior surface 14 of the process tank 12 may be coated with a barrier coating, such as epoxies, polyurethanes, polyureas, and rubber linings to minimise damage thereto. Nevertheless, the coating may develop holidays (i.e. coating failures) or mechanical damage which removes a portion of the coating, thereby exposing the interior surface 14 to the corrosive and abrasive contents of the process tank 12.

To counteract damage to any exposed interior surface 14, the surface monitoring system 10 provides an electrode arrangement for cathodic protection of the process tank 12. The electrode arrangement includes one or more anodes 22 electrically coupled via an insulated conductive line 23 with a DC power supply 24 and the process tank 12, and other components, such as the screen 17, as required, via line 25. The contents 13 of the process tank 12 (i.e. the gold cyanidation liquors) behave as an electrolyte, thereby completing an electrochemical cell.

The anode 22 may be any suitable non-sacrificial anode. Suitable examples of non-sacrificial anodes include, but are not limited to, graphite, titanium, platinum-plated tantalum or mixed metal oxides.

The one or more anodes 22 may be suspended in the process tank 12. In the embodiment shown in the Figures, a first anode 22a is suspended proximal to the agitator 16 and a second auxiliary anode 22b is suspended proximal to the baffles 18 and baffle supports 20. This arrangement is used for complex structure protection to ensure “line of sight” protection.

The DC power supply 24 delivers a predetermined voltage to the anode 22 to passivate and/or polarise or immunise the interior surface 14 of the process tank 12. The predetermined voltage may be from in a range from (-)800 mV to (-)1000 mV, in particular from (-)850 mV to (-)950 mV. In some embodiments, the DC power supply 24 may be operatively associated with a transformer rectifier (not shown) to transform supplied alternating current (AC) to direct current (DC).

The corrosion monitoring system 10 as described herein also includes an electrode array 26 comprising a plurality of reference electrodes 26a, 26b, ...26n mounted on a framework 28. The reference electrodes 26 may be any suitable reference electrode that is capable of remaining stable in the process liquor, such as an Ag/AgCl electrode.

The reference electrodes 26a, 26b, ... 26n are regularly spaced from one another. Referring to the Figures, the reference electrodes 26a, 26b, ... 26n are arranged on the framework 28 in a radial pattern and at increasing heights with respect to a base of the process tank 12 at regular intervals.

While it will be appreciated that the electrode array 26 may generally extend in two-dimensions, in some alternative embodiments the electrode array 26 may extend in one dimension or even three dimensions. For example, the electrode array 26 may extend longitudinally in one dimension in a pipe or riser. Alternatively, the electrode array 26 may be arranged in a series of concentric cylindrical arrangements.

The framework 28 is configured to dispose each reference electrode 26a, 26b, ... 26n proximal to a localised interior surface 14a, 14b, ...14n of the process tank 12. For example, the framework 28 may be a cylindrical lattice which is sized so that the reference electrodes 26 may be radially spaced at a distance of from 50 cm to 200 cm from the interior surface 14. In use, the framework 28 may be suspended in the process tank 12 from an overhead structure 30, such as a gantry, capable of supporting said framework 28 and reference electrodes 26a, 26b, ...26n mounted thereon. Alternatively, the framework 28 may be suspended from an anchor point fixed to the internal surface of the process tank 12.

Each reference electrode 26a, 26b, ... 26n is arranged to measure a local potential indicative of DC power supply set voltage and/or current demand at the localised interior surface 14a, 14b, ... 14n of the process tank 12. The voltage applied between the cathode and anode passivates and/or polarises or immunises the surface 14 of the process tank 12, thereby preventing or reducing corrosion. Under steady state conditions, the current demand will be constant. In the event of a coating failure at one or more localised interior surfaces 14a, 14b, ... 14n, however, there will be an increased localised current demand due to the amount of current required to maintain the surface 14 of the process tank 12 in a passivated and/or polarised or immunised state. The reference electrode 26a, 26b, ... 26n proximal to the localised interior surface 14a, 14b, ... 14n will measure the local potential, a variation being indicative of corrosion being present or occurring.

It will be appreciated that an effective area of the localised interior surface 14a, 14b, ... 14n that is measured by the reference electrodes 26a, 26b, ... 26n will depend on several factors including, but not limited to, the total interior surface area of the process tank 12, the number of reference electrodes 26a, 26b, ... 26n, the spacing between adjacent reference electrodes 26n and 26(n-1), and the radial spacing between the reference electrodes 26a, 26b, ...26n and the interior surface 14. For example, when a greater number of reference electrodes 26a, 26b, ... 26n are employed in the system 10, the effective area of the localised interior surface 14a, 14b, ... 14n decreases, thereby increasing the resolution of the monitoring system 10. Typically, the number of reference electrodes 26a, 26b, ...26n used in the system 10 is selected to provide an effective area of from about 1 m² to about 30 m², in particular from about 4 m² to about 10 m².

The corrosion monitoring system 10 as described herein also includes a monitoring unit 31 arranged to monitor the local potentials measured by respective reference electrodes 26a, 26b, ...26n, which are indicative of the current demand to maintain passivation of the localised interior surfaces 14a, 14b, ... 14n. The monitoring unit 31 may take the form of a central processing unit (CPU) configured for data collection, processing and transfer. The monitoring unit 31 and DC power supply 24 are electrically connected to the electrode array 26 via line 27.

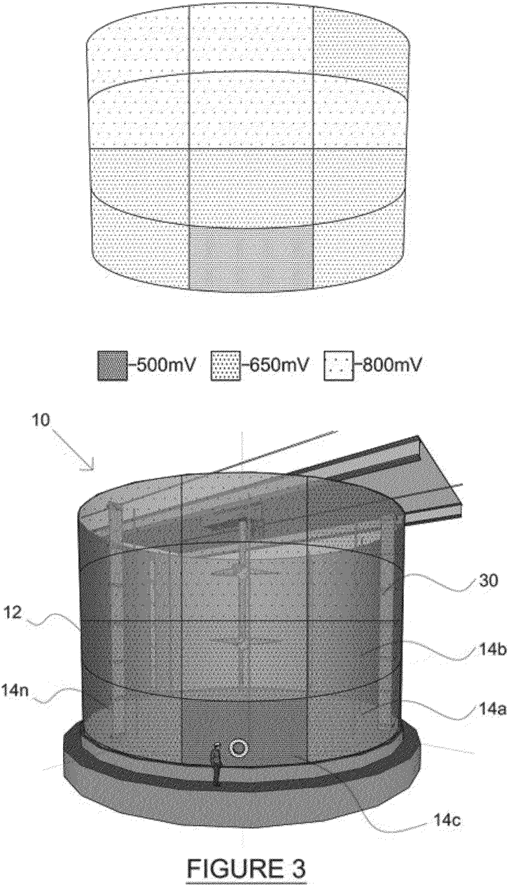

The monitoring unit 31 may be arranged in operative communication with a data storage unit that records and stores data, and a graphic user interface (not shown) to provide a graphical representation of the respective measured local potentials corresponding to the interior surface of the containment structure. The graphical representation may be configured to visually illustrate a variation of the respective measured local potential from the predetermined set potential threshold and/or voltage applied to the structure and thereby identify where corrosion is present or occurring at a localised interior surface of the process tank 12. For example, as shown in FIG. 3, the variation of the respective measured local potential at the localised interior surface may be represented in a different colour or shade intensity to indicate the degree of variation, with deeper shade intensity, for example, corresponding with greater degree of variation in the measured local potential. Alternatively, if there is sufficient resolution, the variation in measured local potential may be represented graphically with contour lines corresponding to increasing or decreasing local potentials.

### Method of Identifying and Quantifying Localised Corrosion

In use, the process tank 12 is provided with an electrode arrangement as described above in which one or more anodes 22 are suspended in the process tank 12 and electrically coupled with the shell of the process tank 12 and the DC power supply 24. The contents 13 of the process tank 12 (i.e. the gold cyanidation liquors) behave as an electrolyte, thereby completing an electrochemical cell.

The DC power supply 24 delivers a predetermined voltage to the one or more anodes 22. Typically, the predetermined voltage will be sufficient to passivate and/or polarise the surface 14 of the shell of the process tank 12. For example, the predetermined voltage may be from (-)800 mV to (-)1000 mV, in particular from (-)850 mV to (-)950 mV (tbc) v Ag/AgCI reference electrode.

The framework 28 on which the spaced reference electrodes 26a, 26b, ... 26n are mounted may be suspended from the overhead structure 30 and immersed in the contents of the process tank 12.

The local potential at the localised surface 14 of the process tank 12 is measured by the respective reference electrode 26a, 26b, ... 26n proximal thereto. The local potential may be measured continuously or intermittently over a period of time.

The measured local potentials are received by the monitoring unit 31 and the collected data is organised and monitored to identify variations of the local potential from the set potential threshold vs. the reference electrode and/or predetermined voltage applied by the DC power supply 24. Variation of the measured local potential from the predetermined voltage applied to the shell of the process tank 12 is indicative of corrosion present or occurring at the localised interior surface.

The DC power supply may be switched off for a period of time to allow a reading to be obtained by the reference electrode array 26 that is free from current flow from the DC power system. This allows for a true reading of local potentials. Such readings may be taken at regular intervals of about 1 h, 24 h or 48 h.

It will be appreciated that when the DC power supply is switched off, the system may be arranged to take readings at 0.5-3 second intervals to measure the subsequent rate of potential decay over a period of time. The readings taken by the reference electrode array 26 may be graphically represented as described above. Under electrolytic protection, the system tends to polarise and/or achieve immunity of any exposed steel. More exposed steel results in increased current draw. Nonetheless, all local potentials should be between (-)850 and (-)950 mV v Ag/AgCl.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

In the claims which follow and in the preceding description except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A surface corrosion monitoring system when used with a gold cyanidation process tank comprising:
an electrode arrangement for the electrolytic protection of the gold cyanidation process tank or component associated therewith, the electrode arrangement comprising an electrode electrically coupled with said structure or component, and a DC power supply arranged, in use, to deliver a predetermined voltage of -800 mV to -1000 mV to the electrode, thereby causing the electrode to behave as an anode and said process tank or component to behave as the cathode, the predetermined voltage being sufficient to passivate and/or polarise or immunise an interior surface of said process tank or component;
an electrode array comprising a plurality of spaced reference electrodes mounted on a framework, wherein the framework is configured to dispose each reference electrode proximal to a localised interior surface of said process tank or component and each reference electrode in said array is arranged to measure a local potential indicative of current demand to maintain passivation and/or polarisation or immunity of the localised interior surface of the process tank or component; and,
a monitoring unit operative to monitor the local potentials measured by respective reference electrodes.

2-4. (canceled)

5. The system according to claim 1, wherein the component comprises one or more of a screen, baffle, baffle support, agitator, one or more pipes in fluid communication with one another for conveying gold cyanidation liquors to or from said process tank.

6. The system according to claim 1, wherein the framework is suspended in said process tank from an overhead structure capable of supporting said framework and reference electrodes mounted thereon or from a plurality of fixing points on the structure.

7. The system according to claim 1, wherein the plurality of reference electrodes are regularly spaced from one another.

8. The system according to claim 1, wherein the framework comprises a cylindrical lattice.

9. The system according to claim 1, wherein the framework is disposed at a distance of about 5 cm to about 20 cm from the interior surface of said process tank.

10. The system according to claim 1, wherein the plurality of reference electrodes are arranged on the framework in a radial pattern within a lateral plane and at intervals within a longitudinal plane.

11. The system according to claim 1, wherein the reference electrode comprises a Ag/AgCl electrode.

12. The system according to claim 1, wherein the monitoring unit is in operative communication with a graphic user interface to provide a graphical representation of the respective measured local potentials the interior surface of said process tank.

13. The system according to claim 12, wherein the graphical representation illustrates a variation of the respective measured local potential from the predetermined voltage applied to said process tank or component and thereby identifies where corrosion is present or occurring at a localised interior surface of the said process tank or component.

14. A method of identifying and quantifying localised corrosion in a gold cyanidation process tank or component associated therewith, the method comprising:
providing an electrode arrangement for the electrolytic protection of said process tank or component, the electrode arrangement comprising an electrode electrochemically coupled with said structure or component, and a DC power supply arranged, in use, to deliver a predetermined voltage of -800 mV to -1000 mV to the electrode, thereby causing the electrode to behave as an anode and said process tank to behave as the cathode;
deliveringthe predetermined voltage of -800 mV to -1000 mV to the electrode to passivate and/or polarise or immunise a surface of said process tank or component;
disposing an electrode array in an interior space defined by said process tank, wherein the electrode array comprises a plurality of equidistantly spaced reference electrodes mounted on a framework, wherein the framework is configured to dispose each reference electrode proximal to a localised interior surface of said process tank or component;
measuring a local potential at the localised surface of said process tank or component with the respective reference electrode, wherein the local potential is indicative of current demand to maintain passivation and/or polarisation or immunity; and
monitoring the local potentials measured at respective localised surfaces of the said process tank to identify and quantify a variation of the local potential from the predetermined voltage.

15. (canceled)

16. The method of claim 14, wherein the predetermined voltage is in a range from (-)850 mV to (-)950 mV.

17. The method of claim 14, wherein variation of the measured local potential from the predetermined voltage applied to said process tank is indicative of corrosion present or occurring at a localised interior surface of said process tank.

18. The method of claim 14, wherein the step of measuring the local potential is performed continuously or intermittently over a period of time.

19. A gold cyanidation process tank comprising a surface corrosion monitoring system as defined in claim 1.

20. The system according to claim 1, wherein the reference electrode comprises a protective shroud.

21. The method of claim 14, wherein the DC power supply is switched off for a period of time when the step of measuring the local potential is performed.
